(19) United States
(12) Patent Application Publication
(10) Pub. No.: US 2022/0099105 A1
(43) Pub. Date: Mar. 31, 2022

(54) DYNAMIC FLUID MACHINE WITH EXPONENTIAL INLET

(71) Applicant: Ingersoll-Rand Industrial U.S., Inc., Davidson, NC (US)

(72) Inventor: Mikhail M. Grigoriev, East Amherst, NY (US)

(21) Appl. No.: 17/039,095

(22) Filed: Sep. 30, 2020

(51) Int. Cl. F04D 29/44; F04D 29/28

(52) U.S. Cl. CPC F04D 29/441; F04D 29/284

(57) ABSTRACT

An inlet includes a nozzle inlet for receiving fluid flow, a nozzle outlet for supplying fluid flow, and an exponential cross-sectional profile configured to control fluid flow to provide a highly uniform flow distribution at the nozzle outlet. The exponential cross-sectional profile of the inlet is defined by a nozzle inlet radius, a nozzle exit radius, a nozzle length, an axial coordinate defined with respect to the nozzle inlet, and an exponential shape constant α. The inlet can be included with a dynamic compressor that has an impeller that receives fluid flow from the inlet and dispenses high velocity fluid flow, a diffuser that receives high velocity fluid flow from the impeller and converts the high velocity fluid flow into a high pressure fluid flow, and a discharge collector that receives the high pressure fluid flow from the diffuser and discharges the high pressure fluid flow from the dynamic compressor.

### BACKGROUND

Dynamic compressors are employed to provide a pressurized flow of fluid for various applications.

### DRAWINGS

The Detailed Description is described with reference to the accompanying figures. The use of the same reference numbers in different instances in the description and the figures may indicate similar or identical items.

FIG. 1 is an isometric view illustrating a centrifugal compressor having an inlet with an exponential cross-sectional profile in accordance with an example embodiment of the present disclosure.

FIG. 2 is an exploded isometric view of the centrifugal compressor illustrated in FIG. 1.

FIG. 3 is an obverse exploded isometric view of the centrifugal compressor illustrated in FIG. 1.

FIG. 4 is a partial cross-sectional side elevation view of the centrifugal compressor illustrated in FIG. 1, taken on the line 4-4 in FIG. 1.

FIG. 5 is a cross-sectional side elevation view of an inlet with an exponential cross-sectional profile for a dynamic fluid machine, such as the centrifugal compressor illustrated in FIG. 1, in accordance with example embodiments of the present disclosure.

FIG. 6 is a graph illustrating an exponential cross-sectional profile of an inlet for a dynamic fluid machine, such as the centrifugal compressor illustrated in FIG. 1, in accordance with example embodiments of the present disclosure.

FIG. 7 is a graph illustrating radial distance versus axial distance for two exponential inlets, an elliptical nozzle, and a Witoszynski nozzle in accordance with example embodiments of the present disclosure.

FIG. 8 is a schematic illustrating isobars on a symmetry plane for a Witoszynski nozzle.

FIG. 9 is a schematic illustrating isobars on a symmetry plane for an elliptical nozzle.

FIG. 10 is a schematic illustrating isobars on a symmetry plane for an exponential inlet in accordance with example embodiments of the present disclosure.

FIG. 11 is a schematic illustrating axial velocity contours on a symmetry plane for a Witoszynski nozzle.

FIG. 12 is a schematic illustrating axial velocity contours on a symmetry plane for an elliptical nozzle.

FIG. 13 is a schematic illustrating axial velocity contours on a symmetry plane for an exponential inlet in accordance with example embodiments of the present disclosure.

FIG. 14 is a graph illustrating pressure versus radial distance at the nozzle outlet of a Witoszynski nozzle.

FIG. 15 is a graph illustrating pressure versus radial distance at the nozzle outlet of an elliptical nozzle.

FIG. 16 is a graph illustrating pressure versus radial distance at the nozzle outlet of an exponential inlet in accordance with example embodiments of the present disclosure.

FIG. 17 is a graph illustrating velocity versus radial distance at the nozzle outlet of a Witoszynski nozzle.

FIG. 18 is a graph illustrating velocity versus radial distance at the nozzle outlet of an elliptical nozzle.

FIG. 19 is a graph illustrating velocity versus radial distance at the nozzle outlet of an exponential inlet in accordance with example embodiments of the present disclosure.

FIG. 20 is a graph illustrating maximum pressure deficit for an exponential inlet with respect to various exponential factors α in comparison to an elliptical nozzle and a Witoszynski nozzle in accordance with example embodiments of the present disclosure.

FIG. 21 is a graph illustrating maximum axial velocity deficit for an exponential inlet with respect to various exponential factors α in comparison to an elliptical nozzle and a Witoszynski nozzle in accordance with example embodiments of the present disclosure.

FIG. 22 is a graph illustrating maximum pressure deficit for an exponential inlet with respect to various nozzle ratios in comparison to an elliptical nozzle and a Witoszynski nozzle in accordance with example embodiments of the present disclosure.

FIG. 23 is a graph illustrating maximum axial velocity deficit for an exponential inlet with respect to various nozzle ratios in comparison to an elliptical nozzle and a Witoszynski nozzle in accordance with example embodiments of the present disclosure.

FIG. 24 is a graph illustrating perceived efficiency losses for an exponential inlet in comparison to an elliptical nozzle and a Witoszynski nozzle in accordance with example embodiments of the present disclosure.

FIG. 25 is a graph illustrating a generalization of the critical α factor in relation to the nozzle ratio of an exponential inlet in accordance with example embodiments of the present disclosure.

FIG. 26 is a schematic illustrating an elliptical nozzle.

FIG. 27 is a schematic illustrating an exponential inlet in accordance with example embodiments of the present disclosure.

### DETAILED DESCRIPTION

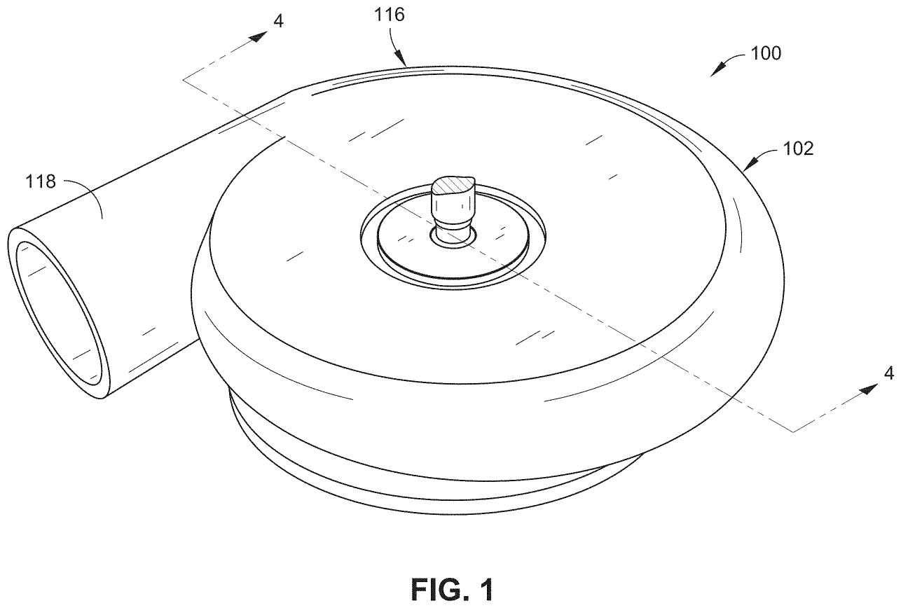

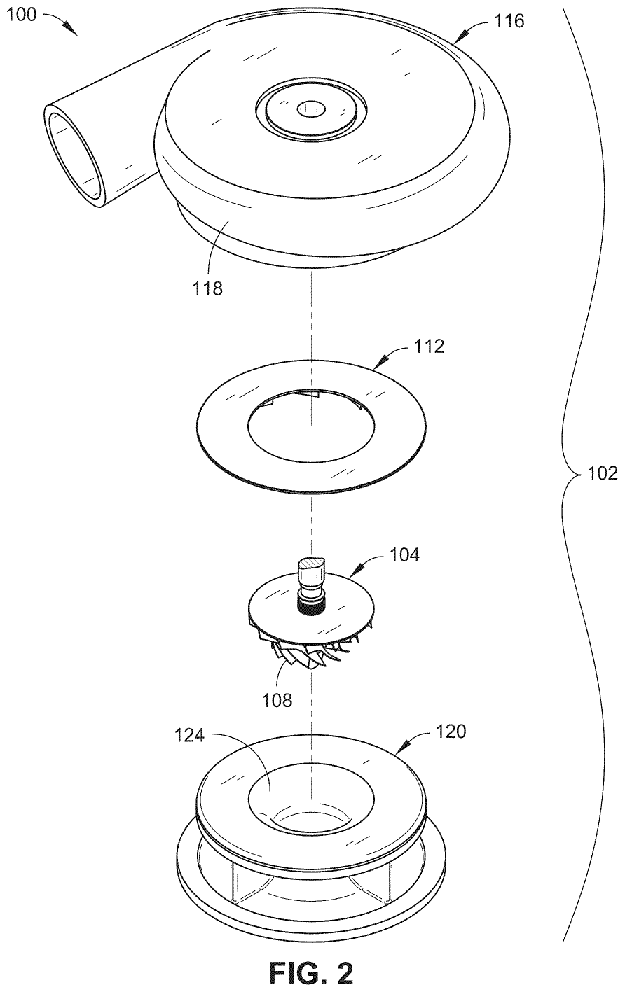

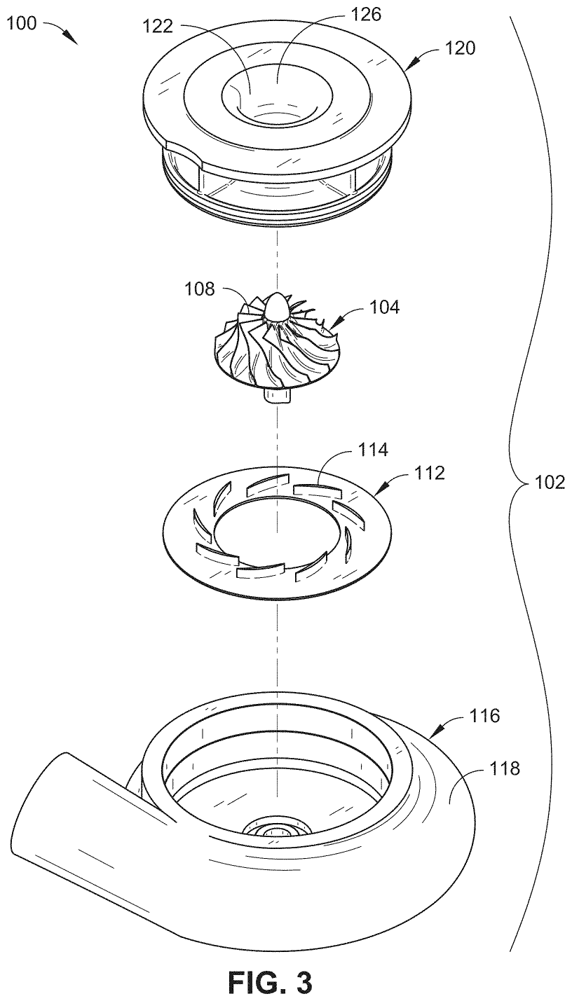

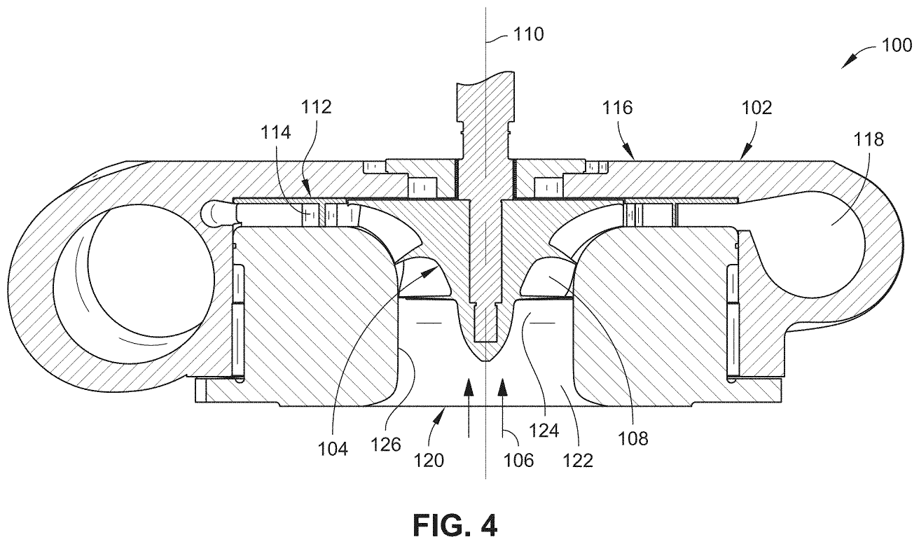

Referring generally to FIGS. 1 through 27, dynamic compressors 100 are described in accordance with example embodiments of the present disclosure. Dynamic fluid machines or turbomachines are mechanical devices that extract energy from a fluid and/or increase the kinetic energy of a fluid. Turbomachines include turbines, pumps, and dynamic compressors, such as axial compressors and centrifugal or radial compressors. Dynamic compressors 100 are rotary continuous-flow machines that accelerate air or gas using a rapidly rotating element. A dynamic compressor 100 uses dynamic displacement compression to compress fluid, such as gas (e.g., air). For example, a dynamic compressor 100 uses a compression impeller that draws gas between impeller blades to accelerate the gas to a high velocity. The gas is then discharged through a diffuser, where the kinetic energy is transformed into static pressure.

In some embodiments, a dynamic compressor 100 can be configured as a centrifugal compressor 102 that provides a pressurized flow of fluid. The centrifugal compressor 102 includes an impeller 104 configured to receive a fluid flow 106, accelerate the fluid flow 106 to a higher velocity, and then dispense the high velocity fluid flow 106. For instance, the impeller 104 includes multiple blades 108 configured to rotate about an axis 110 to receive a fluid flow 106 at least substantially aligned with the axis 110. The impeller 104 can be driven by an electric motor, an internal combustion engine, or another drive unit configured to provide rotational output. In the present example, the impeller 104 accelerates the fluid flow 106 to a higher velocity, and then dispenses the high velocity fluid flow 106 in a direction at least generally perpendicular to the axis 110 (e.g., radially with respect to the axis 110).

The centrifugal compressor 102 also includes a diffuser 112 in fluid communication with the impeller 104. For example, the diffuser 112 is circumferentially disposed around the impeller 104. The diffuser 112 is configured to receive the high velocity fluid flow 106 from the impeller 104 and convert the high velocity fluid flow 106 into a high pressure fluid flow 106. In this manner, the centrifugal compressor 102 produces a high pressure fluid output. In some embodiments, the diffuser 112 may include a series of vanes 114 and/or vanelets. The centrifugal compressor 102 further includes a discharge collector 116 in fluid communication with the diffuser 112. The discharge collector 116 receives the high pressure fluid flow 106 from the diffuser 112 and discharges the high pressure fluid flow 106 from the centrifugal compressor 102. The discharge collector 116 includes a scroll or volute 118 and may include a shroud (not shown) but is not limited to this configuration.

In embodiments of the disclosure, the centrifugal compressor 102 includes an inlet 120 in fluid communication with the impeller 104. The inlet 120 supplies the fluid flow 106 to the impeller 104. The inlet 120 includes a nozzle inlet 122, a nozzle outlet 124, and an exponential cross-sectional profile 126. As described herein, the exponential cross-sectional profile 126 of the inlet 120 is configured to control the fluid flow 106 into the impeller 104 to provide a highly uniform flow distribution at the nozzle outlet 124 of the inlet 120. For instance, the inlet 120 is configured to collect fluid flow (e.g., from an inter-stage cooler or from upstream processes) and then deliver uniform and axisymmetric flow to an inducer section of the impeller 104. It should be noted that the centrifugal compressor 102 is provided by way of example and is not meant to limit the present disclosure. In other embodiments, an inlet 120 as described herein may be used with other various compressors and other dynamic fluid machines or turbomachines, including, but not necessarily limited to axial compressors, turbines, pumps, and so forth.

Generally, compressor efficiency is a function of the inlet, impeller, diffuser, and scroll/volute performance, as well as the interaction between these components. A major problem of centrifugal compressor design and development is flow non-uniformity at the exit of flow conditioning devices at the inlet of the centrifugal stages. Axisymmetric inlet nozzles may use circular arc shapes, elliptical quadrant shapes, or Witoszynski profile shapes. These nozzles perform well in subsonic flows when certain design parameters are met. However, when centrifugal compressors are subject to severe space constraints, these flow devices operate far from the intended parameters. For example, some designs are based upon a nozzle area ratio (i.e., the ratio between the nozzle inlet area and the nozzle outlet area) that is relatively high, exceeding, for example, about fifteen (15). Another condition is that the nozzle aspect ratio (i.e., the ratio between the nozzle axial length and the nozzle radial contraction) is between about two and one-tenth (2.1) to about two and one-half (2.5), with the major axis aligned with the main flow. The first condition implies that the flow entering the nozzle is almost stagnant, and the kinetic energy of the flow is very low. The gas flow then goes through the nozzle and accelerates, thus partially converting potential energy into kinetic energy.

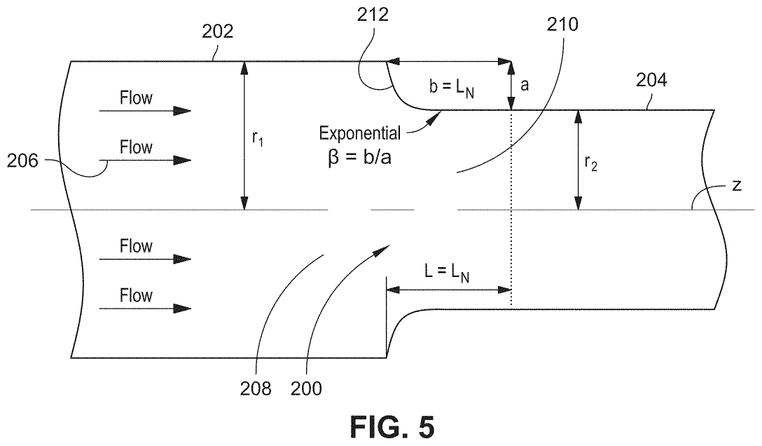

Referring now to FIG. 5, an inlet 200 in accordance with example embodiments of the present disclosure, such as an inlet for a dynamic compressor 100 (e.g., as described with reference to FIGS. 1 through 4), is connected to an inlet pipe 202 and a discharge pipe 204. Fluid flow 206 is directed from a nozzle inlet 208 towards a nozzle outlet 210. The nozzle aspect ratio β is defined as a ratio between the nozzle length and the radial contraction of the nozzle, or

$$β = \frac{L}{( {r}_{1} - {r}_{2} )}$$

In some embodiments, β may be between at least approximately one (1) and at least approximately five (5). For example, β can be between at least approximately two and one-tenth (2.1) and at least approximately two and one-half (2.5). However, it should be noted that these values are provided by way of example and are not meant to limit the present disclosure. In other example, values for β less than about one (1) or greater than about five (5) can also be used.

The effectiveness of the inlet 120 as a flow conditioning device heavily impacts the overall aerodynamic performance of the centrifugal stage of the compressor. For a design to yield high aerodynamic efficiencies, ideal flow conditions should be met. As mentioned previously, ideally, the flow at the entrance of the impeller is irrotational, axisymmetric, and uniform in both radial and circumferential directions. Additionally, the turbulent boundary layer at the entrance of the inducer section of the impeller is as thin as possible. As described herein, the inlet 200 has an exponential cross-sectional profile 212 that serves as the final component of an inlet assembly and completes the flow conditioning process as the fluid flow 206 enters the impeller section of the centrifugal compressor stage. In some embodiments, the shape of the inlet nozzle contour can be adjusted to attain a desired level of cross-sectional flow uniformity.

The exponential cross-sectional profile 212 of the inlet 200 is defined by the following equation:

$$r ( ξ ) = {r}_{1} - ( {r}_{1} - {r}_{2} ) * \frac{( 1 - {e}^{- α * \frac{ξ}{L}} )}{( 1 - {e}^{- α} )}$$

where r₁ is the nozzle inlet radius, r₂ is the nozzle outlet radius, L is the total length of the nozzle, ξ is an axial coordinate with origins at the nozzle inlet, and α is an exponential shape constant. The control parameter, an exponential factor of α, governs the contour shape of the exponential cross-sectional profile 212, thus facilitating a controlled flow acceleration within the inlet 120 to achieve a desired flow pattern at the nozzle outlet 210. The equation is a smooth, continuous, and differentiable function uniquely defined within [r₁, r₂] limits, where r=r₁ when ξ=0, and r=r₂ when ξ=L. The first order derivative at the nozzle inlet 208 is given by the following equation:

$$\frac{dr}{dz} {\vert}_{ξ = 0} = - \frac{α}{L} * \frac{( {r}_{1} - {r}_{2} )}{1 - {e}^{- α}}$$

The first order derivative at the nozzle outlet 210 is given by the following equation:

$$\frac{dr}{dz} {\vert}_{ξ = L} = - \frac{α}{L} * ( {r}_{1} - {r}_{2} ) * \frac{{e}^{- α}}{1 - {e}^{- α}}$$

As inferred from the equation at the nozzle inlet 208, the first order derivative at the nozzle inlet 208 becomes unbounded when parameter α approaches infinity. For this reason, the tangent to the exponential curve is orthogonal to the axis of rotation z. When parameter α approaches infinity at the nozzle outlet 210, the slope to the exponential curve becomes a horizontal line.

When selecting α-parameters between about three (3) and about twenty (20), e.g., about five (5), about five and one-half (5.5), about six (6), about six and one-half (6.5), about seven (7), fluid transitions seamlessly from the nozzle outlet 210 into either a cylindrical section preceding the impeller or directly to the shroud surface. These α-parameters result in a virtually horizontal tangent line at the nozzle outlet 210, e.g., because the first-order derivatives of their respective functions are very small. Meanwhile, the first order derivatives at the nozzle inlet 208 are large; thus, their tangent lines can be almost orthogonal to the axis of revolution z.

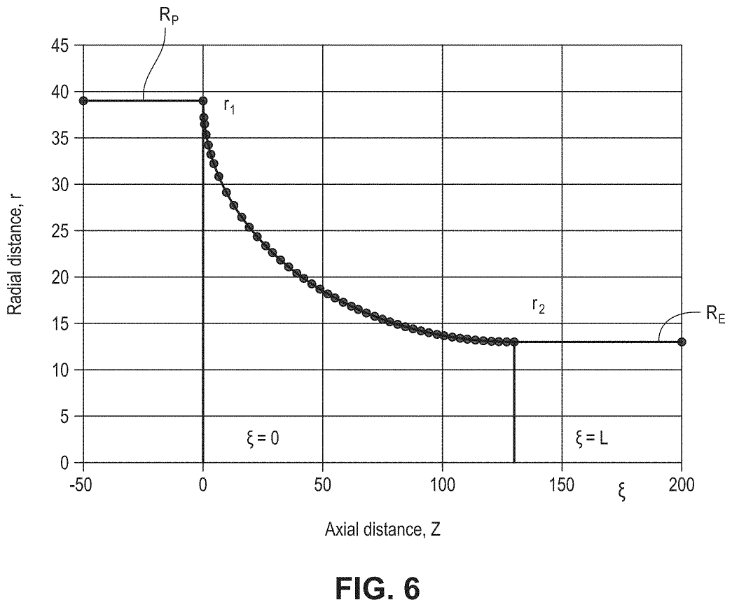

With reference to FIG. 6, an exponential profile based on the exponential cross-sectional profile equation above is shown. The nozzle inlet radius r₁ equals an upstream pipe radius R_{P}, and the nozzle outlet radius r₂ equals a discharge pipe radius R_{E}.

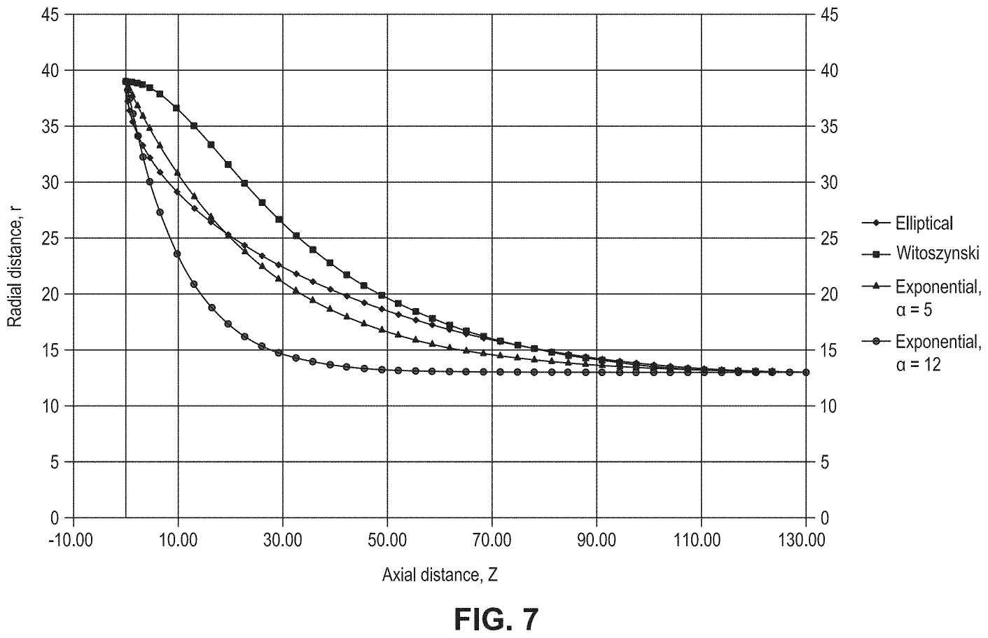

Referring now to FIG. 7, two different profiles for an exponential inlet 200 are shown: a moderately loaded inlet 200 (e.g., when α=5) and a highly loaded exponential inlet 200 (e.g., when α=12). It is noted that the greater the α-factor is, the steeper the contour of the exponential profile. The graph also shows two other nozzle profiles for comparison, an elliptical nozzle profile and a Witoszynski nozzle profile. As shown, the elliptical nozzle profile is similar to the exponential inlet 200 when α=5. The Witoszynski nozzle has much lower first order derivatives along the entire nozzle length. The shapes of these nozzles control the distribution of the aerodynamic loadings in a direction of the axial rotation: the higher the first order derivatives dr/dz are at the vicinity of the nozzle inlet, the higher the loadings are concentrated within the first quarter of the nozzles, while quickly tapering off towards the nozzle outlets.

The exponential inlets 200 initiate flow restructuring earlier than the other nozzles, e.g., by generating higher loadings within the entrance section of the inlets. Since the flow velocities are lower at the nozzle inlet area than further downstream, the flow redistribution penalties in the exponential inlets 200 are lower than in the other nozzles, where the flow restructuring occurs in the downstream parts of the nozzles. For the pre-loaded inlets 200, additional losses are incurred in the downstream section of the inlets where the pre-accelerated flow is left to complete its development, and the velocities are higher than in the elliptical and Witoszynski nozzles. It is noted that the formation of turbulent boundary layers in the downstream section of the exponential inlets 200 may be controlled by the selection of α; thus, boundary layer displacement thicknesses may be only marginally higher than the corresponding values for the elliptical and Witoszynski nozzles.

In these examples, the Witoszynski nozzle is the flow conditioning device with the smallest values of aerodynamic losses, especially for the higher area ratios where the cross-flow distribution is extremely uniform at the nozzle outlet. For the lower area ratio nozzles, which are found in centrifugal compression applications, the Witoszynski nozzles are not sufficiently aggressive to force flow restructuring within severely constrained spaces. Thus, the flow may not be redistributed to yield the desired characteristics at the nozzle outlet. In these instances, further flow conditioning may be necessary. The elliptical nozzles exhibit more aggressive load distribution than the Witoszynski nozzles, which is skewed towards the nozzle inlet section. By forcing the flow redistribution in the early sections of the nozzles, more favorable results at the nozzle outlet albeit may be obtained, but this may be at the expense of higher aerodynamic losses across the nozzle. Provided the losses are no higher than marginal, there a tradeoff can be made between delivering a uniform flow distribution at the nozzle outlet and incurring additional losses. For example, elliptical nozzles are more efficient than the Witoszynski nozzles for centrifugal compression applications with severe spatial constraints.

The exponential inlets 200 of the present disclosure further accelerate the flow redistribution in the inlet sections of the flow conditioning devices. Since the slopes of the exponential inlets 200 can readily be adjusted by the shape parameter α, the aerodynamic loadings can be controlled to yield superior performance from the nozzles. For instance, a decrease of the α-parameter results in more moderate loadings, while an increase leads to more aggressive loadings. Thus, depending on the implementation, the value of α may be easily adjusted to yield sufficiently uniform flow profiles at the nozzle outlet 210, while maintaining aerodynamics losses within acceptable levels. This flexibility allows customization of the exponential nozzle geometry to achieve a desired level of flow uniformity at the nozzle outlet 210, while maintaining the aerodynamic losses at marginal levels. This beneficial tradeoff between flow uniformity and total accumulated losses may be implemented for a wide range of design parameters for various centrifugal compressors, such as the centrifugal compressor 102.

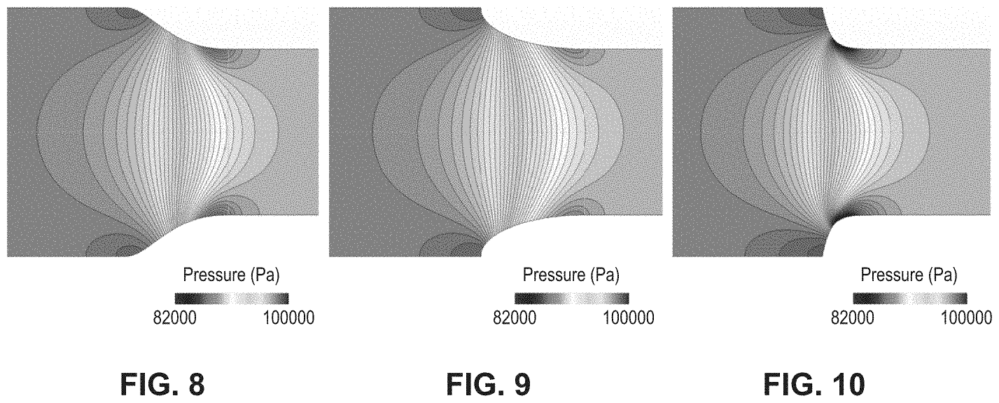

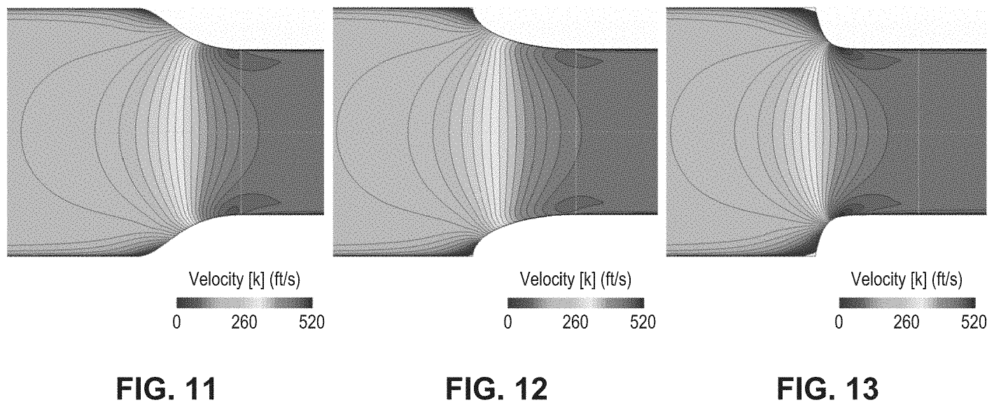

Referring now to FIGS. 8 through 10, isobars of a Witoszynski nozzle (FIG. 8), an elliptical nozzle (FIG. 9), and an exponential inlet 200 (FIG. 10) are shown on a symmetry plane. As seen in FIG. 10, changes in pressure within the exponential inlet 200 happen over a shorter distance within the conditioning device, and flow restructuring is initiated earlier than in the other two nozzles. Similarly, FIGS. 11 through 13 show contours of constant values of axial velocities for a Witoszynski nozzle (FIG. 11), an elliptical nozzle (FIG. 12), and an exponential inlet 200 (FIG. 13) and highlight the flow redistribution mechanism in these nozzles. It can be seen that the aerodynamic loadings are much more aggressive for the exponential inlet 200 than for the other nozzles and that much of the flow redistribution occurs in the first quarter of the exponential inlet 200. In this example, the flow has a sufficient axial distance of slowly-contracting nozzle section to reach equilibrium and complete the flow development process without any significant normal gradients.

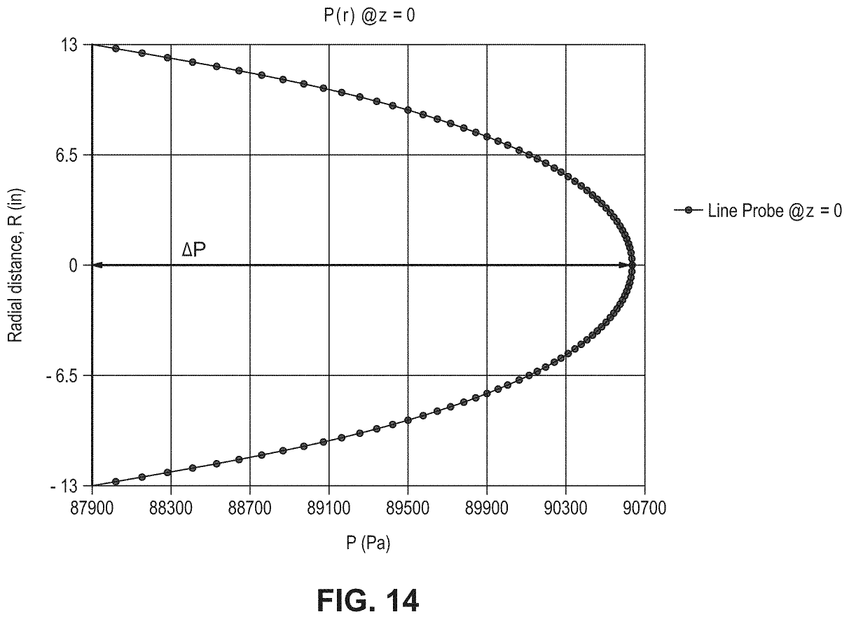

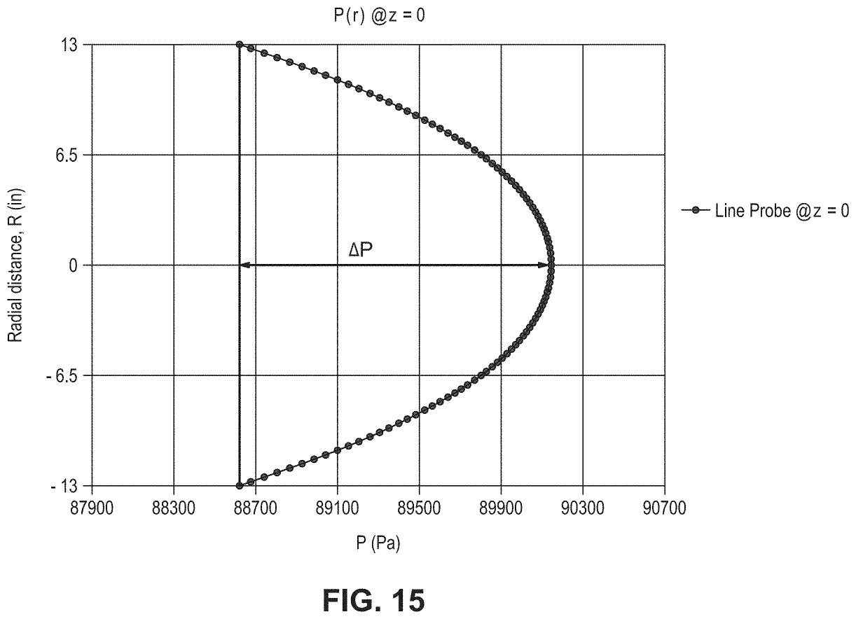

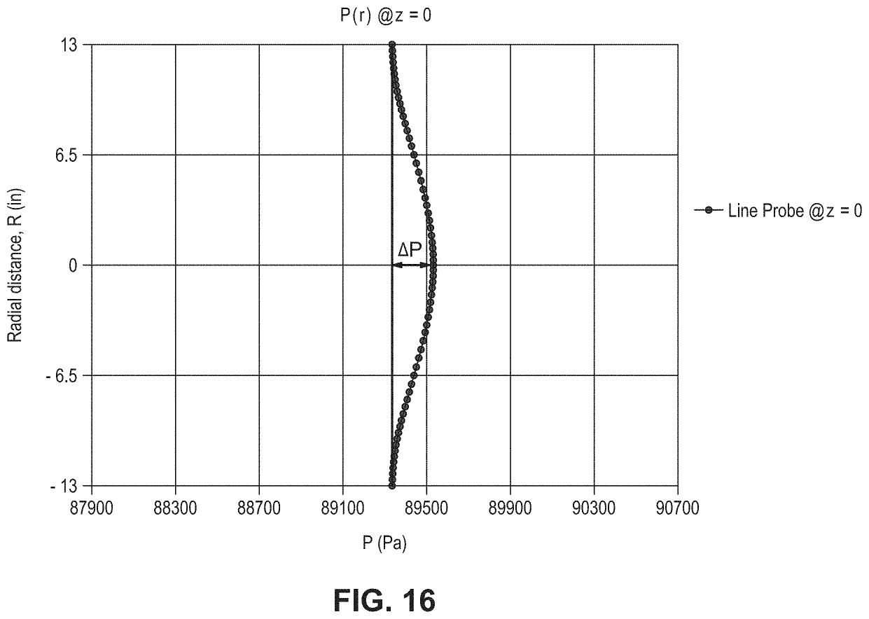

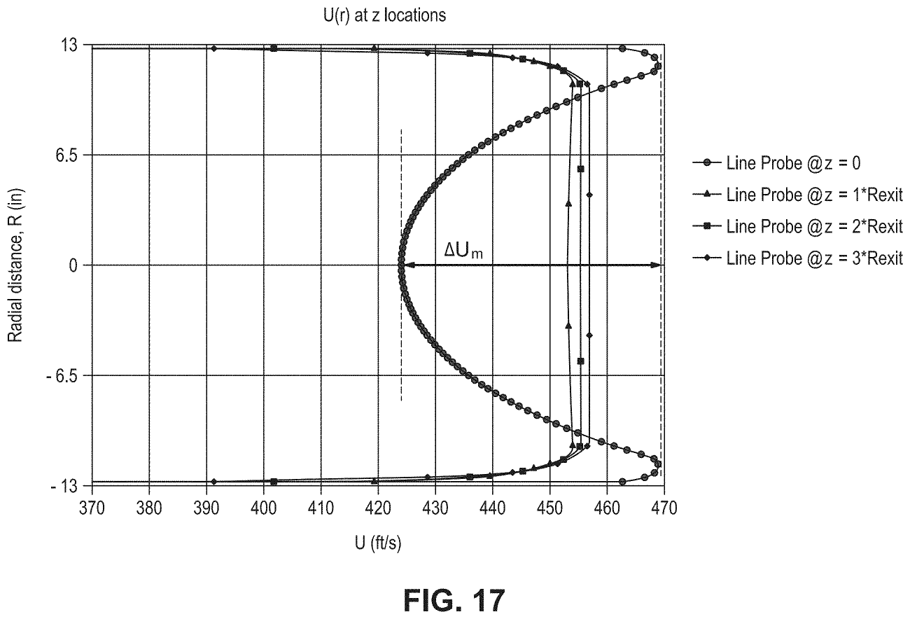

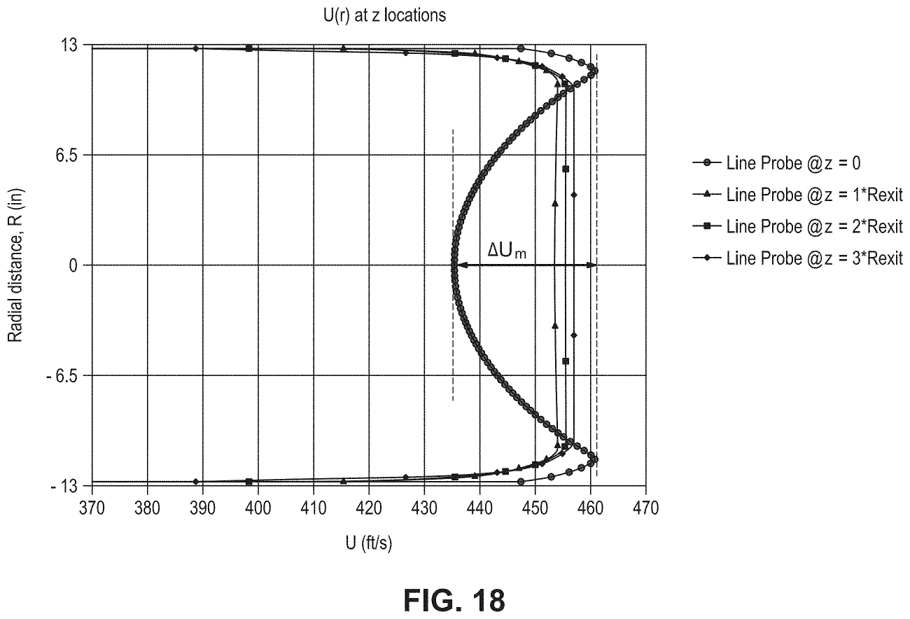

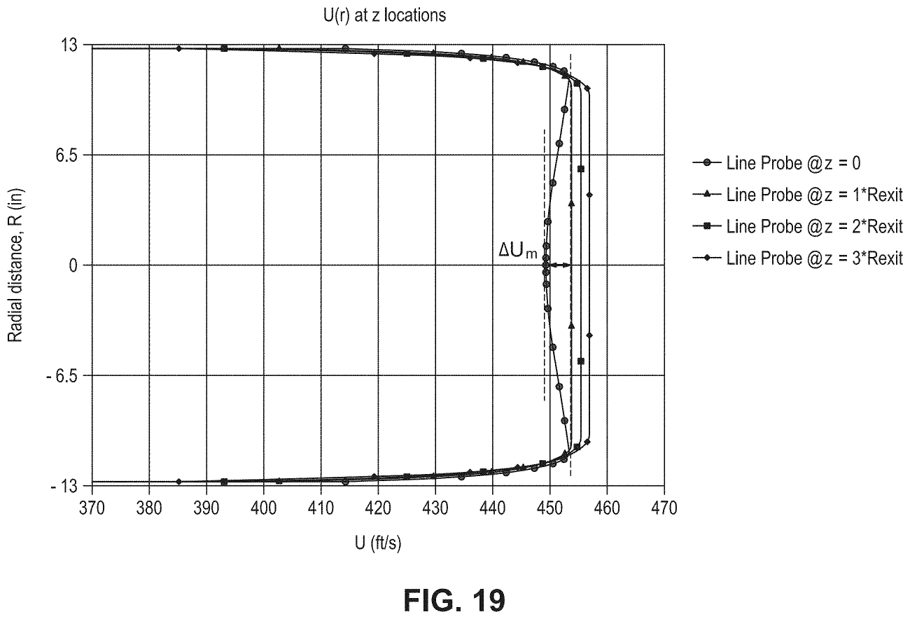

With reference to FIGS. 14 through 16, pressure radial profiles at the nozzle outlet of a Witoszynski profile (FIG. 14), an elliptical profile (FIG. 15), and an exponential nozzle profile (FIG. 16) are shown. As seen in these figures, the flow distribution at the nozzle outlet is significantly more uniform for the exponential inlet 200 than for the Witoszynski and elliptical nozzles. Referring now to FIGS. 17 through 19, velocity profiles at the nozzle outlet of a Witoszynski profile (FIG. 17), an elliptical profile (FIG. 18), and an exponential nozzle profile (FIG. 19) are shown. Similar to the pressure radial profiles, the flow distribution at the nozzle outlet is significantly more uniform for the exponential inlet 200 than for the Witoszynski and elliptical nozzles.

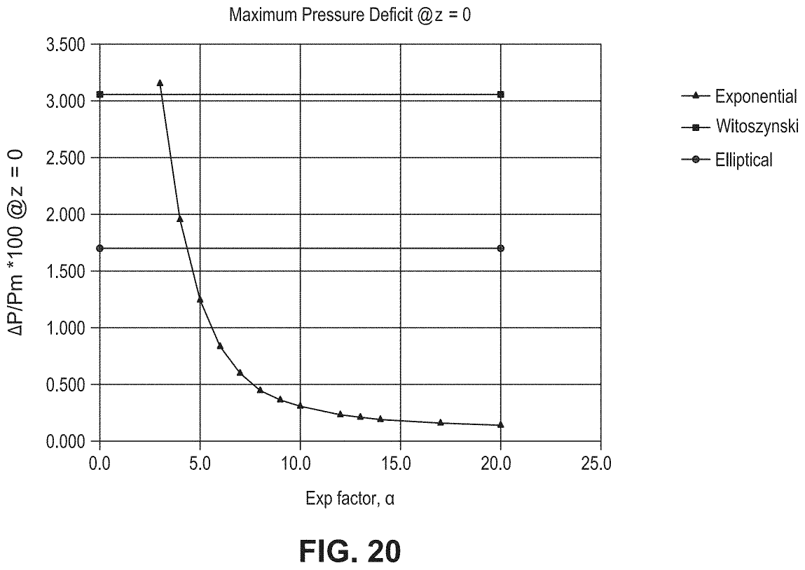

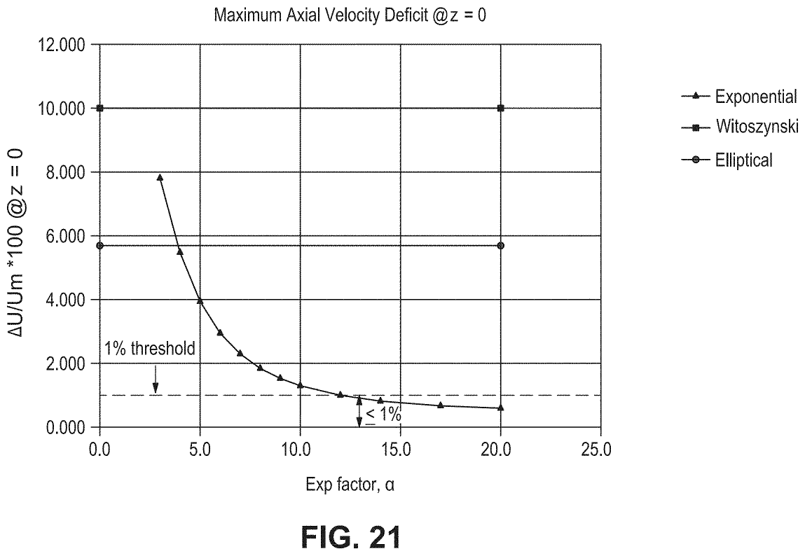

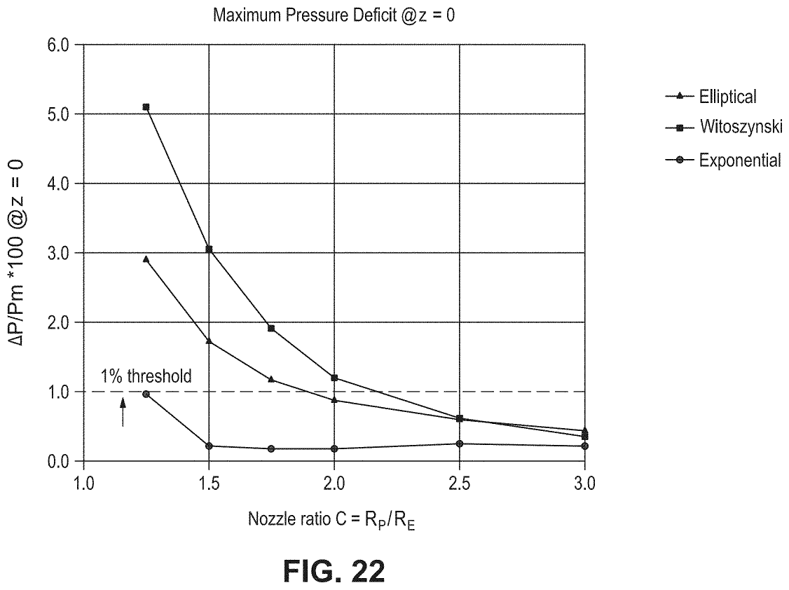

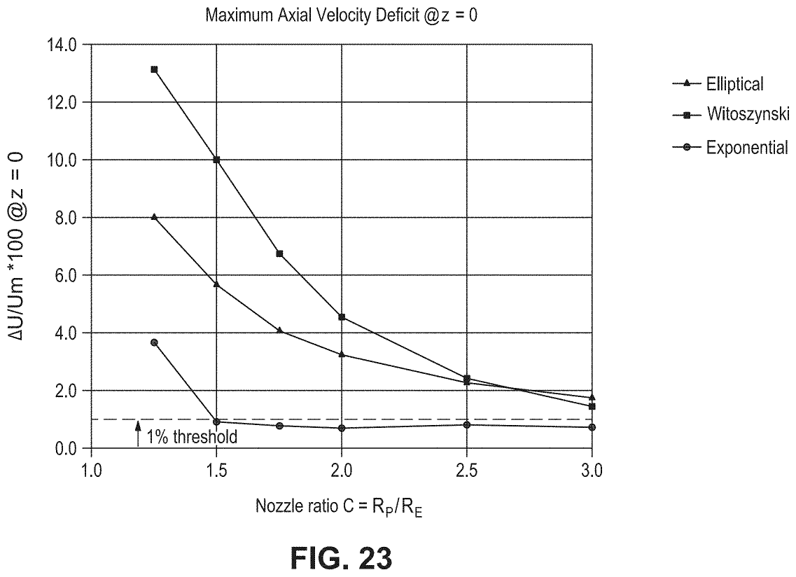

Referring to FIGS. 20 through 23, variations of the maximum pressure and maximum axial velocity deficits at the nozzle outlet are shown to illustrate nozzle effectiveness in flow conditioning. FIGS. 20 and 21 present the maximum pressure deficit and the maximum axial velocity deficit with respect to the α-parameter. The flow non-uniformity metrics decay rapidly as the exponential parameter increases. These metrics are presented as horizontal lines for the elliptical and Witoszynski nozzles. FIGS. 22 and 23 show the maximum pressure and maximum axial velocity deficits at the nozzle outlet with respect to the nozzle radius ratio where C=R_{P}/R_{E}. Assuming an acceptable level of flow non-uniformity of 0.01 (1%), the exponential nozzle can maintain a high degree of flow uniformity for low nozzle radius ratios (e.g., about 1.5). Compared to the Witoszynski and elliptical nozzle designs, the exponential inlet 200 demonstrates better flow uniformity even in the smaller, undersized nozzles, e.g., where C is greater than or equal to about one and one-quarter (1.25).

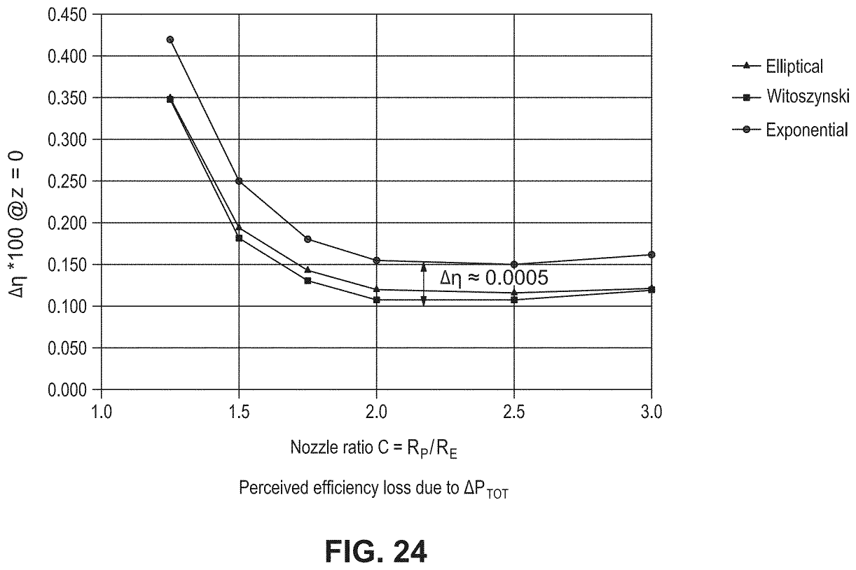

With reference to FIG. 24, perceived efficiency losses of the centrifugal stage due to accumulated total pressure drops across the nozzles can be seen. As illustrated in this figure, the values of the perceived losses of the stage efficiency do not exceed five one-hundredths of a percent (0.05%) of the total stage efficiency and may be considered negligible. This shows that the tradeoff between achieving desired values of the flow non-uniformity metrics and maintaining the acceptable levels of the aerodynamic losses is more than reasonable for the exponential-style nozzles.

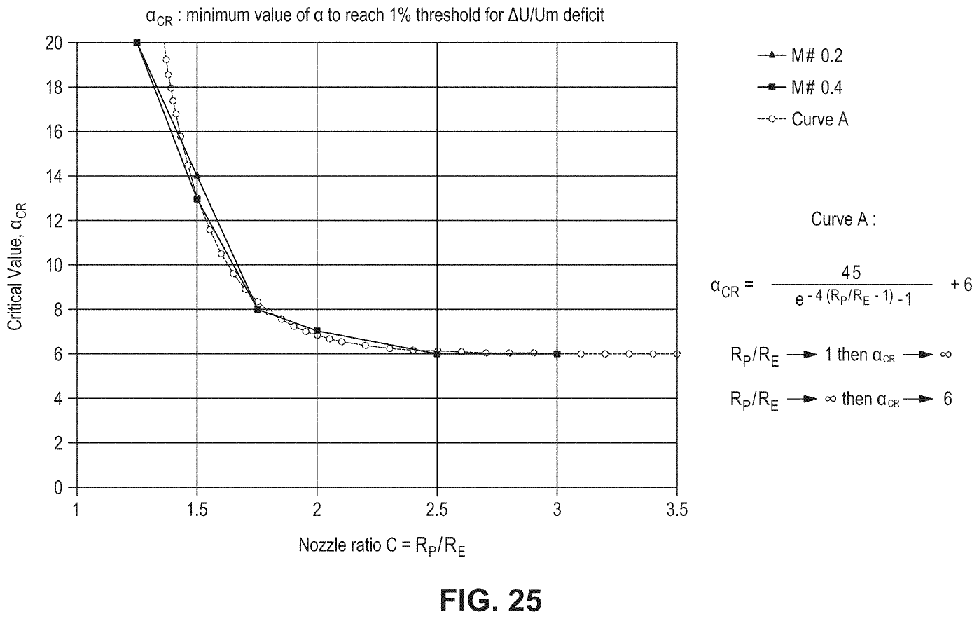

Referring now to FIG. 25, an example of a generalized equation to determine the critical value for the α-parameter to attain the desired level of the flow non-uniformity metrics, set at one-hundredth (0.01) in this example, may be described as follows.

$${α}_{CR} = \frac{45}{{e}^{- 4 ( \frac{{R}_{P}}{{R}_{E}} - 1 )} - 1} + 6$$

This equation was generalized based on hundreds of computational fluid dynamics (CFD) analyses and provides a concise pathway for exponential-shaped nozzles to attain extremely uniform flow conditions at the nozzle outlets while maintaining negligible aerodynamic losses across the flow conditioning units. It should be noted that the generalization for the critical value of the α-parameter may be unique and invariant to the Mach number.

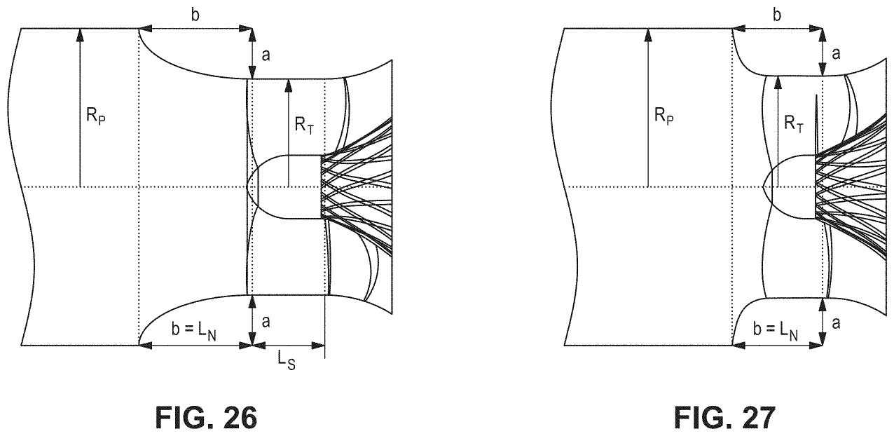

FIGS. 26 and 27 further illustrate the nozzle definition of an elliptical nozzle (FIG. 26) and an exponential nozzle (FIG. 27). As shown, the elliptical nozzle has an aspect ratio of β=b/a with a straight cylindrical section where L_{S}>0. Conversely, the aspect ratio of the exponential nozzle has a straight section length of L_{S}=0. In some embodiments, α may range from at least approximately three (3) to at least approximately twenty (20). For example, α may range from 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 16.0, 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, 20.0 to about 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 16.0, 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, 20.0.

It will be appreciated that while dynamic fluid machines or turbomachines have been described with some specificity herein, the apparatus, systems, and techniques of the present disclosure may be also be applied to other devices where high flow uniformity at a nozzle outlet is desirable, including, but not necessarily limited to, precise flow measurement devices and the like.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A dynamic compressor comprising:
an impeller configured to rotate about an axis to receive a fluid flow at least substantially aligned with the axis, accelerate the fluid flow to a higher velocity, and dispense the high velocity fluid flow in a direction at least generally perpendicular to the axis;
a diffuser circumferentially disposed around the impeller, the diffuser configured to receive the high velocity fluid flow from the impeller and convert the high velocity fluid flow into a high pressure fluid flow;
a discharge collector in fluid communication with the diffuser for receiving the high pressure fluid flow from the diffuser and discharging the high pressure fluid flow from the dynamic compressor;
an inlet in fluid communication with the impeller for supplying the fluid flow to the impeller, the inlet including a nozzle inlet, a nozzle outlet, and an exponential cross-sectional profile, the exponential cross-sectional profile of the inlet configured to control the fluid flow into the impeller to provide a highly uniform flow distribution at the nozzle outlet of the inlet.

2. The dynamic compressor as recited in claim 1, wherein the inlet has an aspect ratio between at least approximately one (1) and at least approximately five (5).

3. The dynamic compressor as recited in claim 1, wherein the inlet has a nozzle radius ratio greater than or equal to at least approximately one and one-quarter (1.25).

4. The dynamic compressor as recited in claim 1, wherein the exponential cross-sectional profile of the inlet is defined by a nozzle inlet radius, a nozzle exit radius, a nozzle length, an axial coordinate defined with respect to the nozzle inlet, and an exponential shape constant α.

5. The dynamic compressor as recited in claim 4, wherein the exponential shape constant α ranges between at least approximately three (3) and at least approximately twenty (20).

6. The dynamic compressor as recited in claim 5, wherein the exponential shape constant α ranges between at least approximately five (5) and at least approximately seven (7).

7. A dynamic compressor comprising:
an impeller configured to receive a fluid flow, accelerate the fluid flow to a higher velocity, and dispense the high velocity fluid flow;
a diffuser in fluid communication with the impeller, the diffuser configured to receive the high velocity fluid flow from the impeller and convert the high velocity fluid flow into a high pressure fluid flow;
a discharge collector in fluid communication with the diffuser for receiving the high pressure fluid flow from the diffuser and discharging the high pressure fluid flow from the dynamic compressor;
an inlet in fluid communication with the impeller for supplying the fluid flow to the impeller, the inlet including a nozzle inlet, a nozzle outlet, and an exponential cross-sectional profile, the exponential cross-sectional profile of the inlet configured to control the fluid flow into the impeller to provide a highly uniform flow distribution at the nozzle outlet of the inlet.

8. The dynamic compressor as recited in claim 7, wherein the impeller is configured to rotate about an axis to receive the fluid flow at least substantially aligned with the axis and dispense the high velocity fluid flow in a direction at least generally perpendicular to the axis.

9. The dynamic compressor as recited in claim 7, wherein the diffuser is circumferentially disposed around the impeller.

10. The dynamic compressor as recited in claim 7, wherein the inlet has an aspect ratio between at least approximately one (1) and at least approximately five (5).

11. The dynamic compressor as recited in claim 7, wherein the inlet has a nozzle radius ratio greater than or equal to at least approximately one and one-quarter (1.25).

12. The dynamic compressor as recited in claim 7, wherein the exponential cross-sectional profile of the inlet is defined by a nozzle inlet radius, a nozzle exit radius, a nozzle length, an axial coordinate defined with respect to the nozzle inlet, and an exponential shape constant α.

13. The dynamic compressor as recited in claim 12, wherein the exponential shape constant α ranges between at least approximately three (3) and at least approximately twenty (20).

14. The dynamic compressor as recited in claim 13, wherein the exponential shape constant α ranges between at least approximately five (5) and at least approximately seven (7).

15. An inlet comprising:
a nozzle inlet for receiving fluid flow;
a nozzle outlet for supplying the fluid flow, the nozzle outlet in fluid communication with the nozzle inlet; and
an exponential cross-sectional profile defined between the nozzle inlet and the nozzle outlet, the exponential cross-sectional profile of the inlet configured to control the fluid flow to provide a highly uniform flow distribution at the nozzle outlet of the inlet, wherein the exponential cross-sectional profile of the inlet is defined by a nozzle inlet radius, a nozzle exit radius, a nozzle length, an axial coordinate defined with respect to the nozzle inlet, and an exponential shape constant α.

16. The inlet as recited in claim 15, wherein the inlet has an aspect ratio between at least approximately one (1) and at least approximately five (5).

17. The inlet as recited in claim 15, wherein the inlet has a nozzle radius ratio greater than or equal to at least approximately one and one-quarter (1.25).

18. The inlet as recited in claim 15, wherein the exponential shape constant α ranges between at least approximately three (3) and at least approximately twenty (20).

19. The inlet as recited in claim 18, wherein the exponential shape constant α ranges between at least approximately five (5) and at least approximately seven (7).

20. The inlet as recited in claim 15, wherein the exponential shape constant α is defined by the function
$$α = \frac{45}{{e}^{- 4 ( \frac{{r}_{1}}{{r}_{2}} - 1 )} - 1} + 6$$
wherein r₁ is the nozzle inlet radius and r₂ is the nozzle outlet radius.
